(19) United States
(12) Patent Application Publication
(10) Pub. No.: US 2010/0131344 A1
(43) Pub. Date: May 27, 2010

(54) ELECTRONIC TRANSACTION METHODS OF A RETAIL MERCHANT WITH A RETAIL CONSUMER

(76) Inventors: Manuel Albeto de Abreu Amorim, Cambridge (CA); Steven D. Williamson, Waterloo (CA)

Correspondence Address: Michael Chan;Intellectual Property Section, Law Department, NCR Corporation, 1700 South Patterson Blvd., Dayton, OH, 45479-0001, US

(21) Appl. No.: 12/277,748

(22) Filed: Nov. 25, 2008

(51) Int. Cl. G06Q 30/00

(52) U.S. Cl. 705/14.23

(57) ABSTRACT

An electronic transaction method is provided of a retail merchant in a transaction conducted between the retail merchant and a retail consumer. The electronic transaction method comprises receiving a request from the retail consumer to purchase a good or service, prompting the retail consumer to provide details associated with a loyalty program account to redeem points and thereby to reduce purchase price of the good or service desired to be purchased, receiving from the retail consumer the details associated with the loyalty program, and reducing purchase price of the good or service based upon the details received from the retail consumer. The loyalty program account may be associated with the retail merchant. The loyalty program account may be associated with a manufacturer who is other than the retail merchant.

### BACKGROUND

The present invention relates to electronic transactions conducted between a retail merchant and a retail consumer, and is particularly directed to electronic transaction methods of a retail merchant with a retail consumer.

In a typical electronic transaction between a retail merchant and a retail consumer, the merchant interacts with the consumer via an electronic device such as kiosk, for example. After the electronic transaction, the merchant provides a receipt to the consumer for having purchased goods or services. The receipt provided to the consumer may be a hard copy paper receipt or a paperless electronic receipt. A known type of electronic receipt allows the merchant to offer post-purchase services to the consumer, such as offering an extended warranty on the goods or services just purchased. After the merchant has delivered the electronic receipt to the consumer, the merchant is unable to offer some types of services to the consumer. As an example, the merchant is unable to offer the consumer a choice as to whether to redeem points from a loyalty program account for the goods or services just purchased by the consumer. As another example, the merchant is unable to offer the consumer a choice as to whether to redeem a rebate or a coupon for the goods or services just purchased by the consumer. It would be desirable to enable the merchant to offer these types of services to the consumer before an electronic receipt for the purchase of goods or services is provided to the consumer.

### SUMMARY

In accordance an embodiment of the present invention, an electronic transaction method is provided of a retail merchant in an electronic transaction conducted between the retail merchant and a retail consumer. The electronic transaction method comprises receiving a request from the retail consumer to purchase a good or service, prompting the retail consumer to provide details associated with a loyalty program account to redeem points and thereby to reduce purchase price of the good or service desired to be purchased, receiving from the retail consumer the details associated with the loyalty program, and reducing purchase price of the good or service based upon the details received from the retail consumer. The loyalty program account may be associated with the retail merchant. The loyalty program account may be associated with a manufacturer who is other than the retail merchant.

### BRIEF DESCRIPTION OF THE DRAWINGS

In the accompanying drawings:

FIG. 1 is a flow diagram depicting a known electronic transaction method of a retail merchant with a retail consumer;

FIG. 2 is a flow diagram depicting steps of an electronic transaction method of a retail merchant with a retail consumer in accordance with an embodiment of the present invention;

FIG. 3 is a flow diagram depicting steps of an electronic transaction method of a retail merchant with a retail consumer in accordance with another embodiment of the present invention; and

FIG. 4 is a flow diagram depicting steps of an electronic transaction method of a retail merchant with a retail consumer in accordance with yet another embodiment of the present invention.

### DETAILED DESCRIPTION

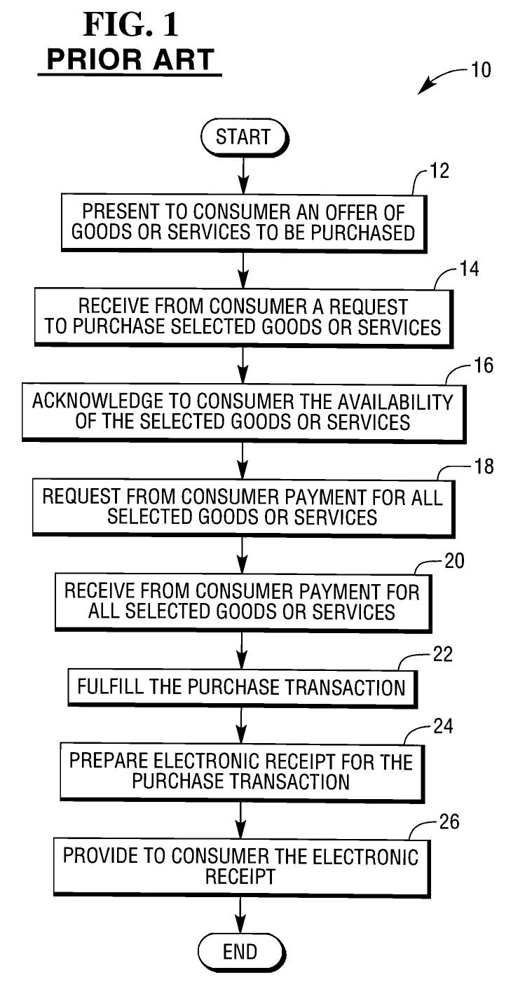

A known electronic transaction method of a retail merchant with a retail consumer is depicted in the flow diagram 10 of FIG. 1. The retail merchant presents to the retail consumer an offer of goods or services to be purchased (step 12). The merchant then receives from the consumer a request to purchase goods or services selected by the consumer (step 14). The merchant acknowledges to the consumer that the selected goods or services are available (step 16), and then requests payment for the selected goods or services (step 18). After the merchant receives payment from the consumer (step 20), the merchant fulfills the purchase transaction (step 22). An electronic receipt is prepared (step 24) and provided to the consumer (step 26). The process of creating of an electronic receipt and the subsequent providing of the electronic receipt to the consumer are well known and, therefore, will not be described.

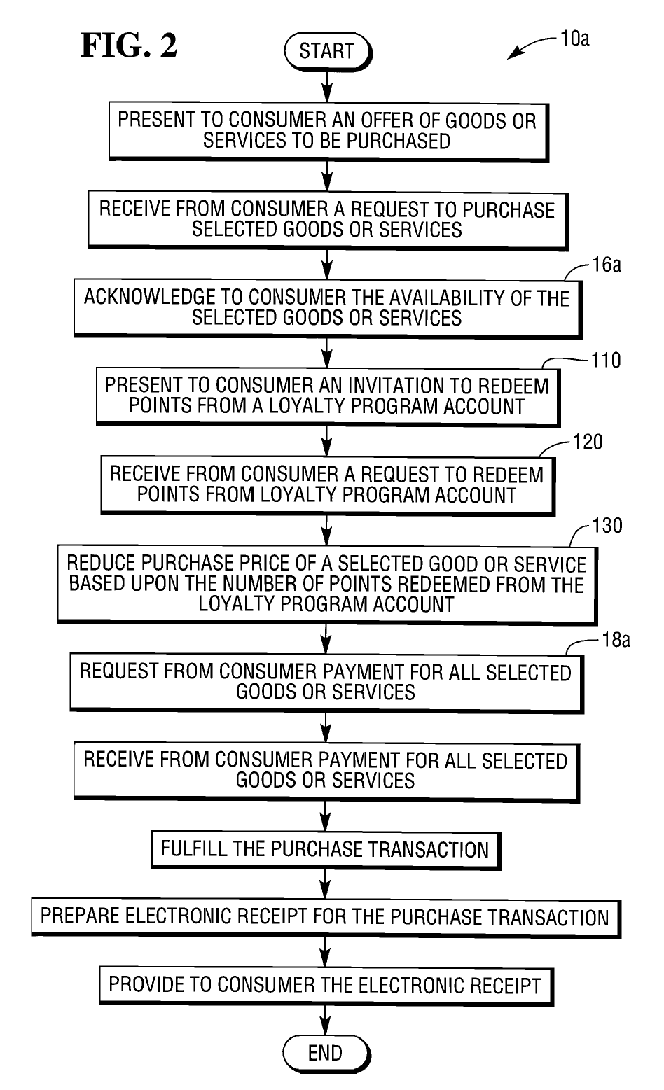

One embodiment of the present invention is illustrated in FIG. 2. FIG. 2 is a flow diagram 10a depicting steps of an electronic transaction method of a retail merchant with a retail consumer in accordance with an embodiment of the present invention. The flowchart 10a of FIG. 2 is generally the same as the flowchart 10 of FIG. 1, except that there are additional steps 110, 120 and 130 in accordance with the present invention shown in the embodiment of FIG. 2. Similar numerals are utilized to designate similar components, the suffix “a” being associated with the embodiment of FIG. 2 to avoid confusion.

As shown in FIG. 2, steps 110, 120 and 130 occur between step 16a at which time the merchant acknowledges to the consumer the availability of the goods or services selected by the consumer and step 18a at which time the merchant requests payment from the consumer for the selected goods or services selected to be purchased. In step 110, the merchant presents an invitation to the consumer inviting the consumer to redeem points from a loyalty program account. The loyalty program account may be associated with the particular merchant, for example. Alternatively, as another example, the loyalty program account may be associated with a particular manufacturer who is other that the merchant.

If the consumer has a loyalty program account from which points can be redeemed and makes a request to redeem points, then the merchant receives the request from the consumer to redeem the points (step 120). The request has the number of points to be redeemed. The merchant reduces the price of a selected good or service based upon the number of points redeemed from the loyalty program account (step 130). This reduces the total payment requested from the consumer for all selected goods or services (step 18a).

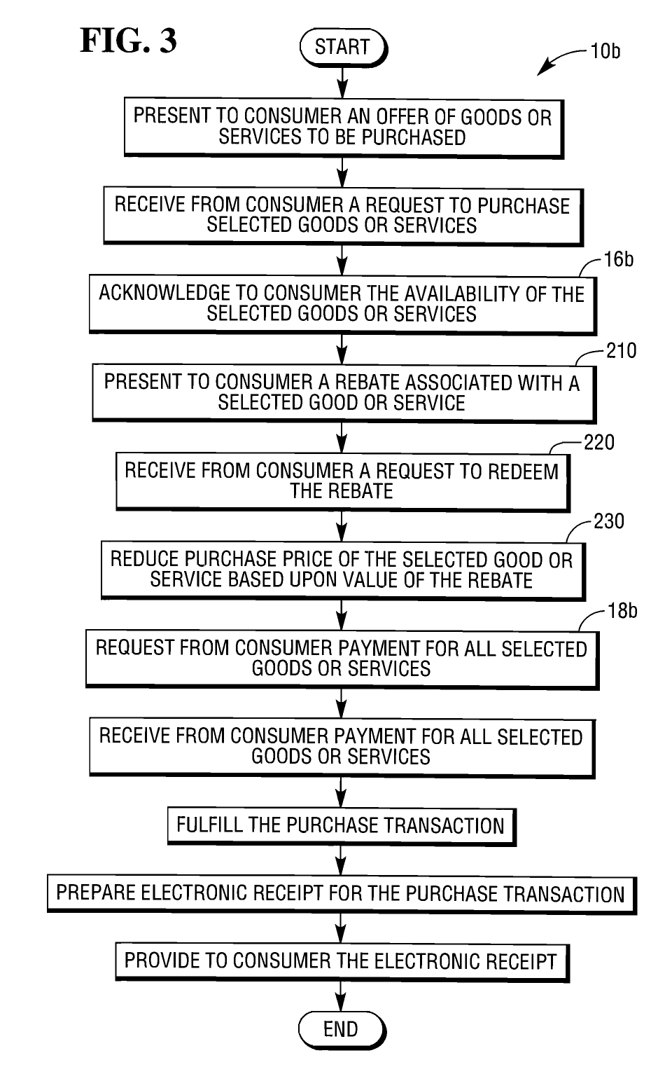

A second embodiment of the present invention is illustrated in FIG. 3. FIG. 3 is a flow diagram 10b depicting steps of a transaction method of a retail merchant with a retail consumer in accordance with the second embodiment of the present invention. The flowchart 10b of FIG. 3 is generally the same as the flowchart 10a of FIG. 2, except that steps 210, 220 and 230 shown in FIG. 3 replace steps 110, 120 and 130 shown in FIG. 2. Similar numerals are utilized to designate similar components, the suffix “b” being associated with the embodiment of FIG. 3 to avoid confusion.

As shown in FIG. 3, steps 210, 220 and 230 occur between step 16b at which time the merchant acknowledges to the consumer the availability of the goods or services selected by the consumer and step 18b at which time the merchant requests payment from the consumer for the selected goods or services selected to be purchased. In step 210, the merchant presents to the consumer a redeemable rebate associated with a selected good or service desired to be purchased. The rebate may be associated with the particular merchant, for example. Alternatively, as another example, the rebate may be associated with a particular manufacturer who is other that the merchant.

If the consumer desires to apply the rebate presented to the consumer in step 210, then the consumer makes a request to apply the rebate. The merchant receives the request from the consumer to apply the rebate (step 220). The merchant then reduces the price of a selected good or service based upon the value of the rebate (step 230). This reduces the total payment requested from the consumer for all selected goods or services (step 18b).

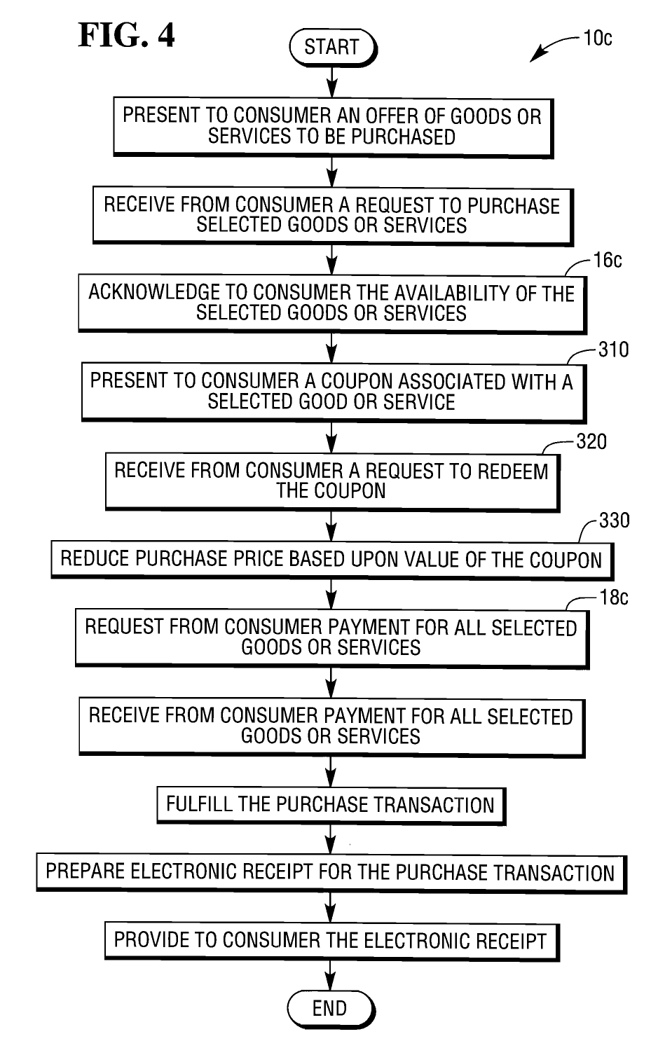

A third embodiment of the present invention is illustrated in FIG. 4. FIG. 4 is a flow diagram 10c depicting steps of a transaction method of a retail merchant with a retail consumer in accordance with the third embodiment of the present invention. The flowchart 10c of FIG. 4 is generally the same as the flowchart 10b of FIG. 3, except that steps 310, 320 and 330 shown in FIG. 4 replace steps 210, 220 and 230 shown in FIG. 3. Similar numerals are utilized to designate similar components, the suffix “c” being associated with the embodiment of FIG. 4 to avoid confusion.

As shown in FIG. 4, steps 310, 320 and 330 occur between step 16c at which time the merchant acknowledges to the consumer the availability of the goods or services selected by the consumer and step 18c at which time the merchant requests payment from the consumer for the selected goods or services selected to be purchased. In step 310, the merchant presents to the consumer a redeemable coupon associated with a selected good or service desired to be purchased. The coupon may be associated with the particular merchant, for example. Alternatively, as another example, the coupon may be associated with a particular manufacturer who is other that the merchant.

If the consumer desires to apply the coupon presented to the consumer in step 310, then the consumer makes a request to apply the coupon. The merchant receives the request from the consumer to apply the coupon (step 320). The merchant then reduces the price of a selected good or service based upon the value of the coupon (step 330). This reduces the total payment requested from the consumer for all selected goods or services (step 18c).

It should be apparent that the above-described electronic transaction methods of a retail merchant with a retail consumer are occurring before a receipt is provided to the consumer. It should also be apparent that the merchant is interacting with the consumer via an electronic device such as a kiosk, for example. The consumer may be interacting either directly with the merchant's electronic device or indirectly with the merchant's electronic device via a handheld mobile electronic device, for example.

The particular arrangements disclosed are meant to be illustrative only and not limiting as to the scope of the invention. From the above description, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims

What is claimed is:

1. An electronic transaction method of a retail merchant in a transaction conducted between the retail merchant and a retail consumer, the electronic transaction method comprising:
receiving a request from the retail consumer to purchase a good or service;
prompting the retail consumer to provide details associated with a loyalty program account to redeem points and thereby to reduce purchase price of the good or service desired to be purchased;
receiving from the retail consumer the details associated with the loyalty program; and
reducing purchase price of the good or service based upon the details received from the retail consumer.

2. An electronic transaction method according to claim 1, wherein the loyalty program account is associated with the retail merchant.

3. An electronic transaction method according to claim 1, wherein the loyalty program account is associated with a manufacturer who is other than the retail merchant.

4. An electronic transaction method according to claim 1, further comprising after the purchase price of the good or service has been reduced, delivering to the retail consumer the good or service purchased to fulfill the transaction.

5. An electronic transaction method of a retail merchant in a transaction conducted between the retail merchant and a retail consumer, the electronic transaction method comprising:
receiving a first request from the retail consumer to purchase a good or service;
presenting to the retail consumer a redeemable rebate associated with a good or service desired to be purchased;
receiving a second request from the retail consumer to redeem the rebate associated with the good or service desired to be purchased; and
reducing purchase price of the good or service based upon the second request received from the retail consumer.

6. An electronic transaction method according to claim 5, wherein the redeemable rebate is associated with the retail merchant.

7. An electronic transaction method according to claim 5, wherein the redeemable rebate is associated with a manufacturer who is other than the retail merchant.

8. An electronic transaction method according to claim 5, further comprising after the purchase price of the good or service has been reduced, delivering to the retail consumer the good or service purchased to fulfill the transaction.

9. An electronic transaction method of a retail merchant in a transaction conducted between the retail merchant and a retail consumer, the electronic transaction method comprising:
receiving a first request from the retail consumer to purchase a good or service;
presenting to the retail consumer a redeemable coupon associated with a good or service desired to be purchased;
receiving a second request from the retail consumer to redeem the coupon associated with the good or service desired to be purchased; and
reducing purchase price of the good or service based upon the second request received from the retail consumer.

10. An electronic transaction method according to claim 9, wherein the redeemable coupon is associated with the retail merchant.

11. An electronic transaction method according to claim 9, wherein the redeemable coupon is associated with a manufacturer who is other than the retail merchant.

12. An electronic transaction method according to claim 9, further comprising after the purchase price of the good or service has been reduced, delivering to the retail consumer the good or service purchased to fulfill the transaction.
